(19) United States
(12) Patent Application Publication
(10) Pub. No.: US 2007/0076166 A1
(43) Pub. Date: Apr. 5, 2007

(54) Optical article

(76) Inventors: Nobuyuki Kobuchi, Higashiosaka-shi (JP); Nobutaka Takami, Higashiosaka-shi (JP); Shinya Kajiri, Higashiosaka-shi (JP)

Correspondence Address: KENYON & KENYON LLP, ONE BROADWAY, NEW YORK, NY, 10004, US

(21) Appl. No.: 11/528,933

(22) Filed: Sep. 27, 2006

(30) Foreign Application Priority Data
Sep. 28, 2005 (JP) 2005-282294

(51) Int. Cl. G02C 5/00

(52) U.S. Cl. 351/151

(57) ABSTRACT

An object of the present invention is to provide a lens suitable in sunglasses or anti-glare spectacles which reduces blue hazard, and by which a blue signal can be confirmed visually, and an optical filter, and an optical article which can cut at least a part of visible light of 380 to 500 nm. The present invention provides an optical article comprising fullerene as a blue light absorbing component.

### FIELD OF THE INVENTION

The present invention relates to an optical article such as sunglasses, anti-glare lenses, shields and optical filters in which blue hazard is reduced.

### BACKGROUND OF THE INVENTION

Sunglasses and anti-glare spectacles are used for reducing bright visible light such as sunlight, or cutting ultraviolet-ray of sunlight.

The function thereof is usually exhibited by coloring a lens base with a dye or a pigment to selectively absorb visible light, or blending an ultraviolet absorbing agent to cut ultraviolet-ray.

Alternatively, by combining with a polarizer, the function of reducing reflected light is imparted (e.g. JP-A No. 8-52817).

Adverse influence of ultraviolet-ray on eyes has been known for a long time. Fortunately, as strategy for ultraviolet-ray, there is an ultraviolet absorbing agent and, at a level of sunlight, ultraviolet-ray can be cut to a not problematic level by a method of adding an ultraviolet absorbing agent to a lens base of sunglasses or anti-glare spectacles.

In recent years, harmfulness of ultraviolet-ray scattered from a side of sunglasses or anti-glare spectacles has been stressed and, as strategy therefor, a goggle type covering a side of eyes has been put into practice.

In the case of visible light, a method of adding a pigment in place of an ultraviolet absorbing agent to a lens base has been adopted. In that case, historically, what a ratio of total visible light can be cut, that is, total visible light transmittance has been used as a criterion.

However, according to the recent study, it has been gradually known that 380 to 500 nm of visible light is harmful to eyes not to an extent of ultraviolet-ray. This is referred to blue hazard and, in sunglasses or anti-glare spectacles, it is said that cutting of this part of wavelength is preferable.

However, when a wavelength of 380 to 500 nm is completely cut, this influences on color sense of a human, it becomes difficult to confirm visually a blue color of a signal and, when one walks on the street, or drives an automobile, inconvenience is produced.

### SUMMARY OF THE INVENTION

Thus, an object of the present invention is to provide a lens which reduces blue hazard, and is suitable for sunglasses or anti-glare spectacles by which a traffic signal can be confirmed visually.

Another object of the present invention is to provide an optical article such an optical filter which can cut at least a part of visible light of 380 to 500 nm.

In order to solve the aforementioned problems, the present inventors paid an attention to fullerene as a blue light absorbing component.

That is, the present invention provides:

(1) an optical article, comprising fullerene as a blue light absorbing component,

(2) the optical article according to (1), wherein the fullerene is fullerene of a carbon number of 70 or a derivative thereof,

(3) the optical article according to (1) or (2), wherein an optical material is a polarizing lens, and

(4) the optical article according to any one of (1) to (3), wherein the optical material contains polycarbonate or transparent nylon as a main component.

### BRIEF DESCRIPTION OF THE DRAWINGS

FIG. 1 is a graph showing a spectral transmittance curve of the C70 (0.0005 weight part)-mixed optical article obtained in Example 1.

FIG. 2 is a graph showing each spectral transmittance curve of the MF-F (0.0005 weight part)-mixed optical article obtained in Example 2, the MF-F (0.05 weight part)-mixed optical article obtained in Example 3, and the MF-F (0.005 weight part)-mixed+polarizing sheet optical article obtained in Example 4.

### DETAILED DESCRIPTION OF THE PRESENT INVENTION

First, fullerenes contained as a blue light absorbing component in the optical article of the present invention is a general name of substances in which carbon atoms form a spherical network structure. For example, when fullerene of a carbon number 60 is expressed as “C60”, C70, C76, C78, C82, and C84 are known in addition to C60.

In addition, fullerenes may be chemically modified, dispersity in a resin can be modified, and optical nature or chemical nature can be changed by adding hydrogen, or imparting a hydroxy group, and any of them can be used in the present invention as far as a spectral transmittance is not considerably changed by chemical modification.

In the present invention, all fullerenes are included, and C70 or a derivative thereof is preferable due to particularly suitable spectral transmittance property.

Further, in order to attain the object of the present invention, fullerenes may by a mixture of fullerenes having different carbon numbers and, in this case, it is preferable that C70 or a derivative thereof is contained in all fullerenes at 10% by weight to 100% by weight.

In addition, together with fullerenes, a dyestuff other than fullerene such as dyes and pigments can be supplementally used.

In a preferable aspect of the present invention, fullerenes is contained in a resin, and the resin containing fullerenes is processed into optical articles such as lenses and optical filters of sunglasses or anti-glare spectacles.

A resin may be any of a thermoplastic resin and a thermosetting resin, and a transparent resin is preferable.

Examples of the thermoplastic resin suitably used in the present invention are not limited to, but include a polycarbonate resin, a transparent nylon resin, a polyester resin, an acryl resin, a polyurethane resin, a polystyrene resin, an acrylonitrile.styrene resin, a norbornene resin and a cellulose-based resin.

Among them, in utilities of lenses and optical filters of sunglasses or anti-glare spectacles, a polycarbonate resin and a transparent nylon resin are particularly preferable from a viewpoint of high impact resistance strength and high transparency.

In the case of a thermoplastic resin, a mixture of fullerenes and a powder of a thermoplastic resin or a mixture with the manufactured pellets can be injection-molded to prepare optical articles such as lenses and optical filters of sunglasses or anti-glare spectacles.

Alternatively, once fullerene is kneaded to prepare pellets, and this can be injection-molded.

Examples of the thermosetting resin suitably used in the present invention are not limited to, but include cured monomers used in preparing corrective lenses, such as a diethylene glycol diallyl carbonate monomer, a diallyl phthalate monomer, a mixture of an isocyanate-based compound and polyol or polythiol, and an acryl monomer.

In the case of a thermosetting resin, fullerenes is mixed and dispersed in a monomer of a thermosetting resin, and cured by so-called cast molding method, thereby, optical articles such as lenses and optical filters of sunglasses or anti-glare spectacles can be prepared.

When the present invention is applied to a polarizing lens, in a stage of preparing an optical article, one polarizer is added.

That is, when the present invention is practiced with a thermoplastic resin, usually, a monoaxially stretched polyvinyl alcohol film is used as a base for a polarizer, this is dyed with iodine or a dichromic dyestuff to prepare a polarizer, and a protective sheet made of polycarbonate, transparent nylon or acetyl cellulose is applied to both sides of a polarizer via an adhesive to prepare a polarizing plate having a sandwich structure in which a polarizer is situated at a center.

Then, a polarizing plate is bent in a lens-like manner, the polarizing plate bent in a lens-like manner is inserted into a mold of injection molding, and a thermoplastic resin such as a polycarbonate resin is imparted to a rear side of a polarizing plate in a thick manner by a so-called insert injection molding method.

In this case, as a method of containing fullerenes, in addition to a method of kneading into a thermoplastic resin to be injection-molded, there is a method of kneading into a protective sheet of a polarizing plate, or kneading into an adhesive adhering a polarizer and a protective sheet.

In addition, when the present invention is practiced with a thermosetting resin, a polarizer bent in a lens-like manner, or a polarizing plate obtained by applying one protective sheet to a polarizer, or a polarizing plate formed into a sandwich structure with two protective sheets, each being bent in a lens-like manner, is inserted into a mold for cast molding and, according to a conventional method of cast molding, a monomer of a thermosetting resin is filled, cured, and molded.

In this case, as a method of containing fullerenes, there is a method of mixing or dispersing in a monomer of a thermosetting resin, kneading into a protective sheet of a polarizing plate, or kneading into an adhesive adhering a polarizer and protective sheet.

Alternatively, there is a method of adhering a polarizing plate which has been bent in a lens-like manner in advance, and a lens-like molded product of a thermoplastic resin or a thermosetting resin with an adhesive.

In this case, as a method of containing fullerenes, there is a method of kneading fullerenes into a protective sheet of a polarizing plate, an adhesive adhering a polarizer and a protective sheet, a thermoplastic resin or a thermosetting resin monomer, or an adhesive adhering a polarizing plate and a lens-like molded product.

An addition rate of fullerenes is different depending on a kind of fullerene, use purpose of an optical article such as sunglasses and anti-glare spectacle lenses, and a place to which fullerene is added such as a lens and an adhesive, and should be determined in such a range that a luminous transmittance TV (see below) of a completed optical article is generally 12% by weight to 85% by weight. When a luminous transmittance is less than 12% by weight, for example, there is a possibility that a problem arises in utility of driving and, when a luminous transmittance exceeds 85% by weight, an optical article approaches transparency, and there is a possibility that the light reducing effect is lost. For example, in the case of mixed fullerene, for example, when mixed into a polycarbonate resin at a lens thickness of 2.15 mm, an addition rate of fullerenes is 0.001% by weight to 0.1% by weight.

Particularly, when the present invention is applied to lenses of sunglasses or anti-glare spectacles, strategy for blue hazard is attained by adding a large amount of fullerene. However, limitless addition arises a problem of making visual confirmation of a traffic signal difficult.

Then, an addition rate of fullerenes should be determined in such a range that blue hazard preventing effect is sufficient, and a traffic signal can be sufficiently confirmed visually, in view of the aforementioned range of a luminous transmittance. Specifically, for example, an addition rate of fullerenes should be determined so as to satisfy standard.

According to European Standard (EN 1836) for sunglasses or anti-glare filters, blue hazard and visibility of a traffic signal are defined as follows.

Blue Hazard:

For a wavelength 380 to 780 nm of a D65 light source, let τV represent a luminous transmittance calculated from spectral transmittance measured at 10 mm intervals.

For a wavelength 380 to 500 nm of a D65 light source, let τB represent a blue light transmittance calculated from a spectral transmittance measured at 10 mm intervals.

It is desirable that requirement for clearing blue hazard is τB<1.2τV.

Visibility of Signal:

Each spectral transmittance measured at 10 nm intervals for a wavelength 380 to 780 nm of a D65 light source, and each coefficient of blue, green, yellow, and red separately predetermined at 10 nm intervals for a wavelength 380 to 780 nm are multiplied every each wavelength, and a sum thereof is let to be a signal lamp recognition transmittance (τ sign) of each color.

A Q factor of each color is defined as follows.
Q factor=signal lamp recognition transmittance/τV
Requirement for clearing visibility of a signal is as follows:
Q factor (blue)≧0.4
Q factor (green)≧0.6
Q factor (yellow)≧0.8
Q factor (red)≧0.8

### EXAMPLES

The following Examples illustrate the present invention in more detail.

### Example 1

0.005 part by weight of fullerene C70 (C70 98% or more) manufactured by Frontier Carbon was mixed into 100 parts by weight of a polycarbonate resin (TARFLON FN-2200 A manufactured by Idemitsu Kosan Co., Ltd.), and the mixture was extruded with an extruder (manufactured by Ikegai Corporation) to obtain polycarbonate resin pellets with 0.005 part by weight of C70 mixed therein.

The resin was injection-molded to mold a lens for sunglasses having an external shape 80Φ, a concave curve 65 mmR, and a central thickness of 2.51 mm, thereby, (1) an optical article with 0.005 part by weight of C70 mixed therein was obtained.

The optical article of (i) was measured with a spectrophotometer U-4100 manufactured by Hitachi, Ltd., and a transmittance τV, blue light τB, visibility of a signal were calculated. Results are shown in Table 1.

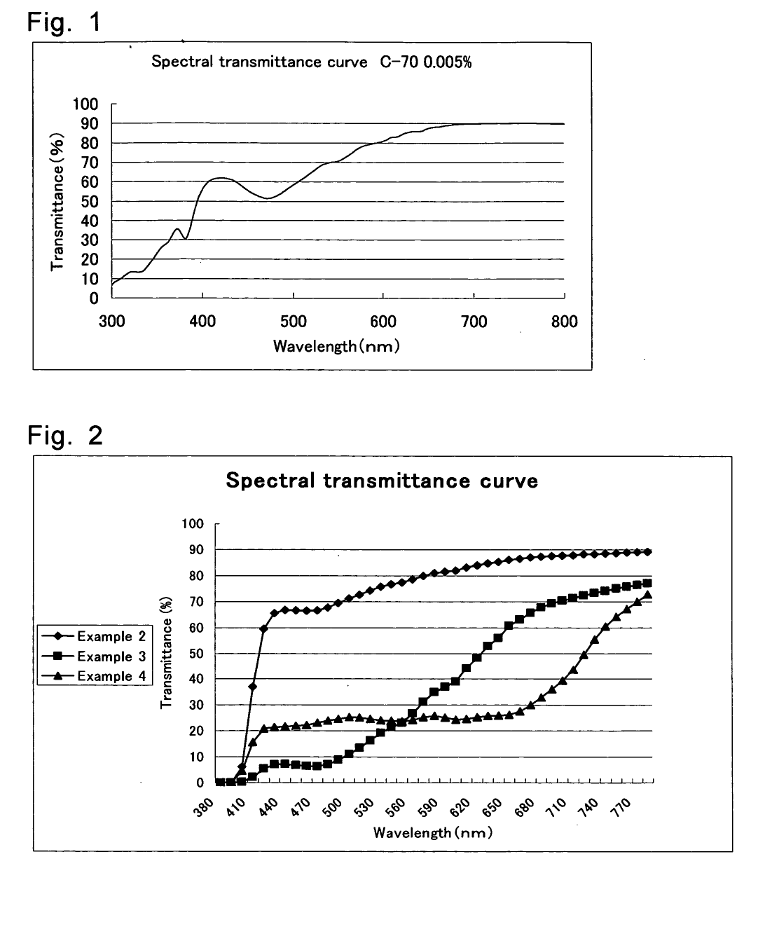

In addition, a spectral transmittance curve of (i) the optical article with 0.005 part by weight of C70 mixed therein is shown in FIG. 1.

TABLE 1
Signal lamp recognition transmittance and Q-factor of
optical article of Example 1

| | Red | Yellow | Green | Blue |
|---|---|---|---|---|
| Signal lamp | 83.88% | 79.03% | 68.13% | 65.45% |
| recognition | | | | |
| transmittance | | | | |
| Q-factor | 1.16 | 1.09 | 0.94 | 0.91 |
| Determination | PASS | PASS | PASS | PASS |
| Determination | 0.8. | 0.8. | 0.6. | 0.4. |
| standard | | | | |

According to EN 1836, .V was calculated to be 72.3% and B was calculated to be 56%, a blue light transmittances was 1.2 .V or lower, and it was found out that there is no problem of blue hazard.

### Examples 2 to 4

0.1 part by weight of JF79 (ultraviolet absorbing agent manufactured by Johoku Chemical Co., Ltd.), and (ii) 0.005 part by weight (Example 2) or (iii) 0.05 part by weight (Example 3) of Nanom Mix MF-F (mixture of about 60% of C60, about 25% of C70, and high-order fullerenes of carbon number 76 or more) were mixed into 100 parts by weight of a polycarbonate resin (TARFLON FN-2200 A manufactured by Idemitsu Kosan Co., Ltd.), and the mixture was extruded with an extruder (manufactured by Ikegai Corporation) to obtain polycarbonate resin pellets with two kinds of (ii) and (iii) of fullerenes mixed therein.

The resin was injection-molded to mold a lens for sunglasses having an external shape of 80Φ, a concave curve of 65 mmR, and a central thickness of 2.15 mm, to obtain (ii) an optical particle with 0.005 part by weight of MF-F mixed therein (Example 2) and (iii) an optical particle with 0.05 part by weight of MF-F mixed therein (Example 3).

In addition, a polarizing sheet made of polycarbonate (PGC-1301; manufactured by Tsutsunaka Plastic Industry Co., Ltd., thickness 0.8 mm) was bending-processed into a sphere of 65 mmR, inserted into a mold, and molded with (ii) a polycarbonate resin with 0.005 part by weight of MF-F mixed therein to obtain (iv) MF-F 0.005 weight part-mixed+polarizing sheet optical article (Example 4) having an external shape of 82Φ, a concave curve of 65 mmR, and a central thickness of 2.15 nm.

Optical articles of (i) to (iv) were measured with a spectrophotometer U-4100 manufactured by Hitachi, Ltd. and, based on sunglasses standard of EN (Europe) .ANSI (USA) .AS (Australia), a spectral transmittance, a blue light transmittance, and visibility of a signal of each of them were calculated. Results on EN Standard are shown in Table 2, results on ANSI Standard are shown in Table 3, and results on AS Standard are shown in Table 4.

TABLE 2
Results on EN Standard

| | | | Example 2 | | Example 3 | | Example 4 | |
|---|---|---|---|---|---|---|---|---|
| | | | Measured | | Measured | | Measured | |
| | | | value | Determination | value | Determination | value | Determination |
| EN | Luminous | | 77.9 | — | 27.5 | — | 24.6 | — |
| 1836 | Transmittance | | | | | | | |
| | τV(%) | | | | | | | |
| | Filter Category | | 1 | — | 2 | — | 2 | |
| | Sunlight UV | | 0.00 | PASS | 0.00 | PASS | 0.00 | PASS |
| | transmittance | | | | | | | |
| | (τSUV)(280˜380) | | | | | | | |
| | nm | | | | | | | |
| | Blue light | | 64.2 | (PASS) | 6.6 | (PASS) | 21.8 | (PASS) |
| | (380˜500) % | | | | | | | |
| | Blue light | | | | | | | |
| | transmittance | | | | | | | |
| | (τB)(1.2τV > τB) | | | | | | | |
| | For Drive(500˜650) | | 71.2 | PASS | 11.0 | PASS | 23.7 | PASS |
| | nm0.2τV< | | | | | | | |
| | Recognition | Red | 1.08 | PASS | 1.76 | PASS | 1.04 | PASS |
| | of | 0.8≦ | | | | | | |
| | Signal | Yellow | 1.04 | PASS | 1.38 | PASS | 1.02 | PASS |
| | light | 0.8≦ | | | | | | |
| | and | Green | 0.97 | PASS | 0.76 | PASS | 0.99 | PASS |
| | Colors | 0.6≦ | | | | | | |
| | (Q- | Blue | 0.96 | PASS | 0.74 | PASS | 1.01 | PASS |
| | FACTOR) | 0.4≦ | | | | | | |

TABLE 3
Results on ANSI Standard

| | | | Example 2 | | Example 3 | | Example 4 | |
|---|---|---|---|---|---|---|---|---|
| | | | Measured | | Measured | | Measured | |
| | | | value | Determination | value | Determination | value | Determination |
| ANSI | Luminous | | 78.0 | — | 27.7 | — | 24.7 | — |
| Z80.6 | Transmittance | | | | | | | |
| | τV(%) | | | | | | | |
| | Function | | Cosmetic Use | | General | | General | |
| | | | | | Purpose | | Purpose | |
| | Sunlight UVB | | 0.00 | PASS | 0.00 | PASS | 0.00 | PASS |
| | transmittance | | | | | | | |
| | UVB(290˜315) nm | | | | | | | |
| | Sunlight UVA | | 0.00 | PASS | 0.00 | PASS | 0.00 | PASS |
| | transmittance | | | | | | | |
| | UVA(315˜380) nm | | | | | | | |
| | Traffic | Red | 85.3 | PASS | 55.65 | PASS | 26.6 | PASS |
| | Signal | 8%≦ | | | | | | |
| | Recognition | Yellow | 81.3 | PASS | 37.58 | PASS | 25.1 | PASS |
| | | 6%≦ | | | | | | |
| | | Green | 75.9 | PASS | 21.1 | PASS | 24.4 | PASS |
| | | 6%≦ | | | | | | |
| | Color | D65 | X = 0.333 | PASS | X = 0.452 | PASS | X = 0.323 | PASS |
| | Limits | | Y = 0.348 | | Y = 0.410 | | Y = 0.342 | |
| | (X and | Yellow | X = 0.570 | PASS | X = 0.611 | PASS | X = 0.570 | PASS |
| | Y) | | Y = 0.419 | | Y = 0.379 | | Y = 0.409 | |
| | | Green | X = 0.217 | PASS | X = 0.298 | PASS | X = 0.210 | PASS |
| | | | Y = 0.420 | | Y = 0.520 | | Y = 0.413 | |

TABLE 4
Results on AS Standard

| | | | Example 2 | | Example 3 | | Example 4 | |
|---|---|---|---|---|---|---|---|---|
| | | | Measured | | Measured | | Measured | |
| | | | value | Determination | value | Determination | value | Determination |
| AS | Luminous | | 77.9 | — | 27.5 | — | 24.6 | — |
| 1076 | Transmittance | | | | | | | |
| | τV(%) | | | | | | | |
| | Lens Category | | 1 | — | 2 | — | 2 | — |
| | Sunlight UV | | 0.11 | PASS | 0.01 | PASS | 0.09 | PASS |
| | transmittance | | | | | | | |
| | τSUV(280˜400) nm | | | | | | | |
| | Solar blue | | 64.3 | — | 6.56 | — | 21.8 | — |
| | light | | | | | | | |
| | τSB %(400˜500) nm | | | | | | | |
| | Minimum | | 66.5 | PASS | 6.3 | PASS | 21.9 | PASS |
| | Transmittance | | | | | | | |
| | (450˜650) nm | | | | | | | |
| | 0.2τV< | | | | | | | |
| | Recognition | Red | 1.08 | PASS | 1.76 | PASS | 1.04 | PASS |
| | of | 0.8≦ | | | | | | |
| | Signal | Yellow | 1.04 | PASS | 1.38 | PASS | 1.02 | PASS |
| | light | 0.8≦ | | | | | | |
| | and | Green | 0.97 | PASS | 0.76 | PASS | 0.99 | PASS |
| | Colors | 0.6≦ | | | | | | |
| | (Q- | Blue | 0.96 | PASS | 0.74 | PASS | 1.01 | PASS |
| | FACTOR) | 0.7≦ | | | | | | |

A view of a spectral transmittance curve of (ii) an optical particle with 0.005 part by weight of MF-F mixed therein of Example 2, and (iii) an optical particle with 0.05 part by weight of MF-F mixed therein, and a graph of a spectral transmittance curve of (iv) MF-F 0.005 weight part-mixed+polarizing sheet optical article of Example 4 are shown in FIG. 2.

(ii) An optical particle with MF-F 0.005 part by weight mixed therein of Example 2, (iii) an optical particle with 0.05 part by weight of MF-F mixed therein of Example 3, and (iv) MF-F 0.005 weight part-mixed+polarizing sheet optical article satisfy Standard of each country, and suitably reduce blue light of 380 to 500 nm from a spectral curve.

Optical articles of Examples 1 to 4 were cut into a lens shape, and actually used as a completed sunglass article. A lens had no defect such as black point, color ununiformity and the like, and had the better dispersed state. Since in a field test, blue light was suitably reduced, scattered light was suppressed, contours of far buildings or clouds were seen clearly, being comfortable. In addition, a blue signal could be sufficiently confirmed visually, and it was confirmed that yellow and red signals can be discriminated without any problem.

According to the present invention, a lens which can reduce blue hazard, and is suitable for sunglasses or anti-glare spectacles by which a traffic signal can be confirmed visually, can be provided,

In addition, according to the present invention, an optical article such as an optical filer which can cut at least a part of visible light of 380 to 500 nm can be provided.

What is claimed is:

1. An optical article, comprising fullerene as a blue light absorbing component.

2. The optical article according to claim 1, wherein the fullerene is fullerene of a carbon number of 70 or a derivative thereof.

3. The optical article according to claim 1 or claim 2, wherein an optical material is a polarizing lens.

4. The optical article according to claim 1, wherein the optical material contains polycarbonate or transparent nylon as a main component.

5. The optical article according to claim 2, wherein the optical material contains polycarbonate or transparent nylon as a main component.

6. The optical article according to claim 3, wherein the optical material contains polycarbonate or transparent nylon as a main component.
